(19) United States
(12) Patent Application Publication
(10) Pub. No.: US 2012/0288273 A1
(43) Pub. Date: Nov. 15, 2012

(54) INTELLIGENT SPLITTER MONITOR

(75) Inventors: Wolfgang W. Pöhlmann, Hemmingen (DE); Jorg Hehmann, Weil der Stadt (DE); Michael Straub, Maulbronn (DE); Joseph L. Smith, Fuquay-Varina, NC (US)

(73) Assignee: Alcatel-Lucent USA, Inc., Murray Hill, NJ (US)

(21) Appl. No.: 13/106,088

(22) Filed: May 12, 2011

(51) Int. Cl. H04B 10/08

(52) U.S. Cl. 398/9

(57) ABSTRACT

One aspect provides an optical communication system. The system includes an optical combiner, an optical tap, and a controller. The optical combiner is configured to receive a first optical signal at a first port of a plurality of ports. The optical tap is associated with the first port and is configured to divert a portion of the first optical signal. The controller is configured to monitor the diverted portion and to create an ID message including an identification datum associated with the port in the event that the diverted optical signal is detected.

### TECHNICAL FIELD

This application is directed, in general, to optical transmission systems and, more specifically, to systems, apparatus and methods of determining system connectivity.

### BACKGROUND

A typical fiber-in-the-home (FITH) passive optical network (PON) includes an optical line terminal (OLT) located in a central office (CO) of a service provider. The OLT may serve multiple end users, or optical network units (ONUs), via a single optical path. The optical path may split at an optical splitter into several branch paths, with each branch path connected to a single ONU by a port of the splitter.

### SUMMARY

One aspect provides an optical communication system. The system includes an optical combiner, an optical tap, and a controller. The optical combiner is configured to receive a first optical signal at a first port of a plurality of ports. The optical tap is associated with the first port and is configured to divert a portion of the first optical signal. The controller is configured to monitor the diverted portion and to create an ID message including an identification datum associated with the port in the event that the diverted optical signal is detected.

Another aspect provides a method. The method includes locating a first optical tap to divert a portion of a first optical signal directed to a first port of a plurality of ports of an optical combiner. A controller is configured to monitor the diverted optical signal and to create an ID message including an identification datum associated with the port in the event that the diverted optical signal is detected.

In another aspect a method of operating a passive optical network is provided. In one step a first optical signal is transmitted via an optical path. The first optical signal bears a first message to an optical network unit. The message directs the optical network unit to transmit a second optical signal bearing a second message. In another step a combiner port of a splitter/combiner is monitored for the presence of the second optical signal. In another step a third optical signal is transmitted via the optical path. The third optical signal bears an ID message identifying the combiner port.

### BRIEF DESCRIPTION

Reference is now made to the following descriptions taken in conjunction with the accompanying drawings, in which:

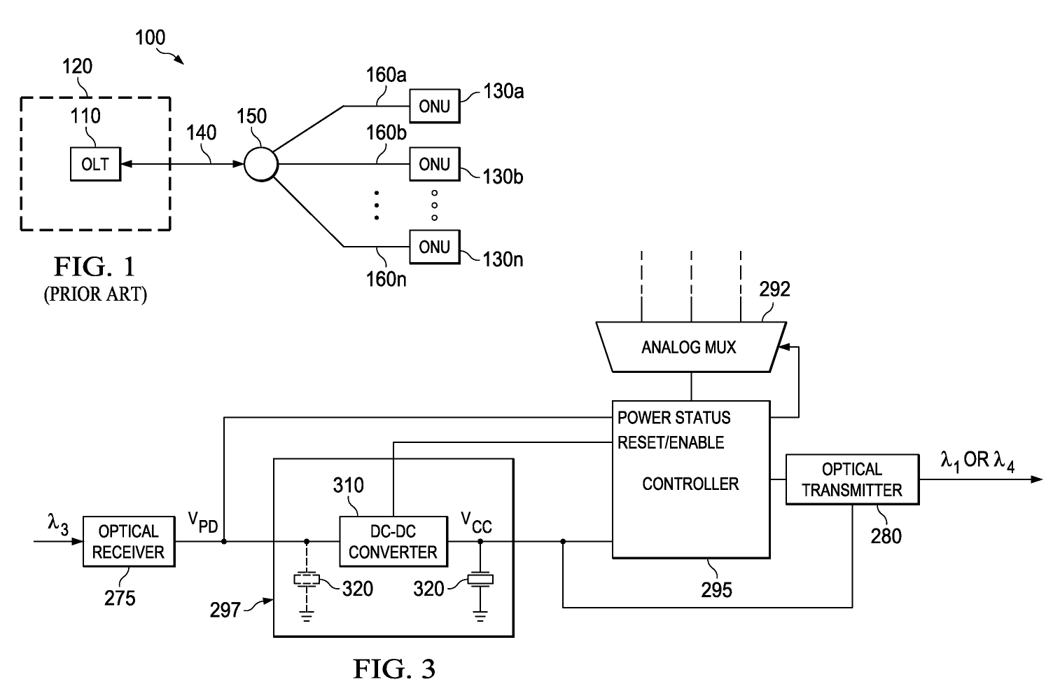

FIG. 1 illustrates a prior art passive optical network;

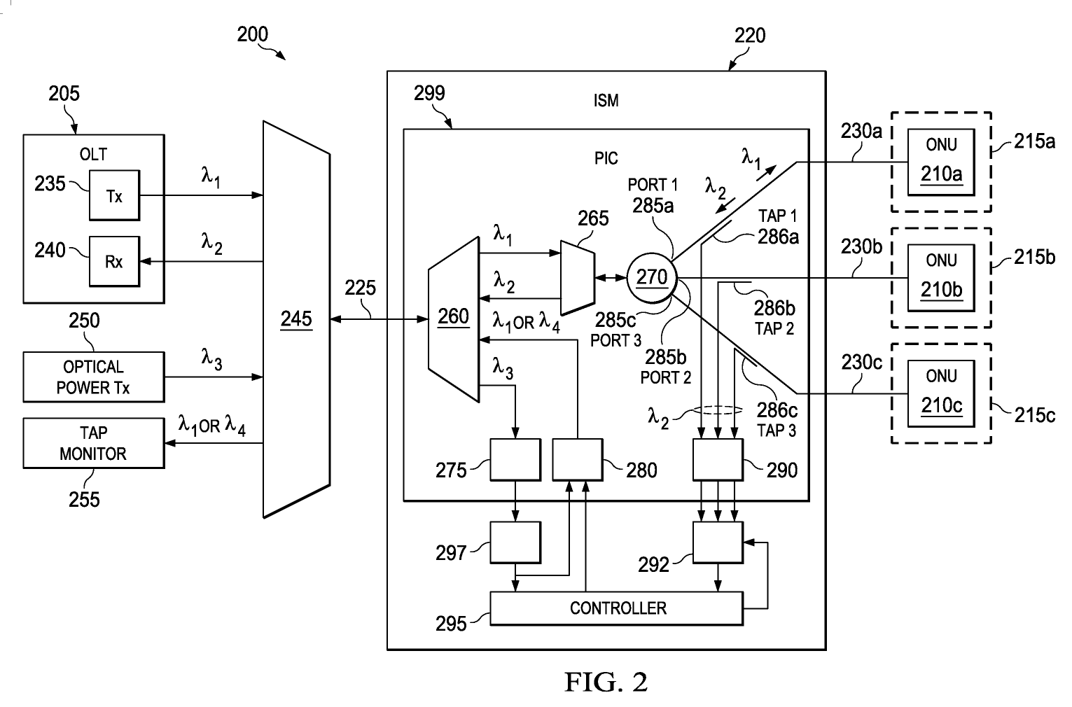

FIG. 2 presents an optical communication system according to one embodiment of the disclosure, e.g. a passive optical network;

FIG. 3 illustrates aspects of the optical system of FIG. 2 in one embodiment of the disclosure, including a controller configured to report an identification datum of a splitter/combiner port that receives an optical signal;

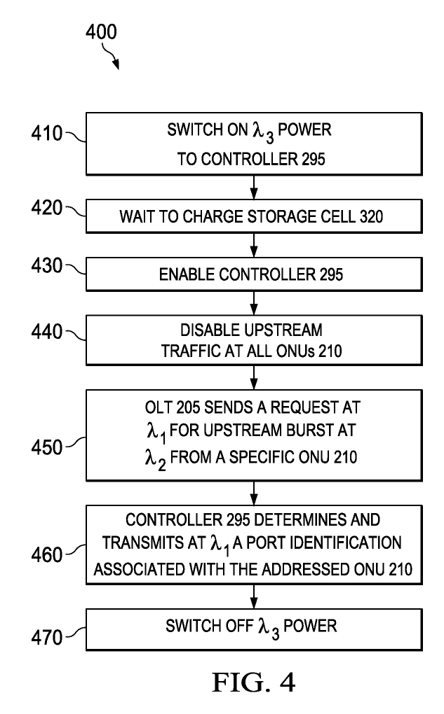

FIG. 4 illustrates a method of operating the system of FIGS. 2 and 3; and

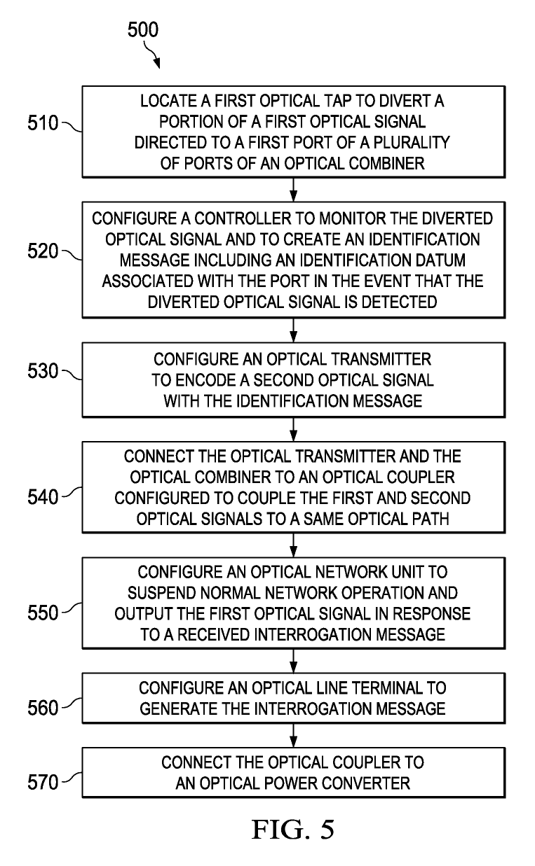

FIG. 5 presents a method, e.g. for manufacturing the system of FIGS. 2 and 3.

### DETAILED DESCRIPTION

Embodiments of optical devices and systems are described herein for remotely identifying an optical splitter port in a PON to which an ONU is connected. This disclosure benefits from the recognition by the inventors that such identification may be provided by a remote electronic system collocated with the port that operates on command from an OLT in communication with the ONU. Such embodiments and others within the scope of the disclosure may significantly reduce the cost of identifying the ports relative to conventional methods.

FIG. 1 illustrates a prior art passive optical network (PON) 100. The network 100 includes an optical line terminal (OLT) 110, typically located at a central office (CO) 120. The OLT 110 communicates with optical network units (ONUs) 130a, 130b . . . 130n using an optical source via an optical path such as a fiber optical cable 140. Downstream data from the OLT 110 are addressed to one of the ONUs 130, each of which is configured to recognize data addressed to it. The optical cable 140 connects to a splitter/combiner 150. The splitter/combiner 150 divides the optical signal from the OLT 110 between a number of ports, e.g. ports 160a, 160b . . . 160n. Each ONU 130 may also transmit upstream data to the OLT 110 via the optical cable 140. Optical signals from each ONU 130 are combined by the splitter/combiner 150 and propagate to the OLT 110.

If an end-user of one of the ONUs 130 experiences a service disruption, the service provider may need to identify the specific port 160 to which the affected ONU 130 is connected. Sometimes the port is identified in records generated when the system 100 is installed, maintained or upgraded. Often, however, such records do not exist or are inaccurate, and the particular port 160 associated with the affected ONU 130 cannot be identified without a personal inspection by a service technician to the site of the splitter/combiner 150 and/or the affected ONU 130 or its associated demarcation point (DP, not shown). If an incorrect port is disconnected during network servicing, service may be disrupted to a user other than the intended user. In some cases the splitter/combiner 150 is tens of kilometers from the CO 120 and/or the affected ONU 130. A coordinated test of the ONU 130 and identification of a desired splitter port 160 conventionally typically requires a two-person team, e.g. one person located at the site of the splitter/combiner 150, and one person located at the site of the ONU 130 of interest. Thus, the service call may be time-consuming and/or expensive.

FIG. 2 illustrates a system 200 according to one embodiment, e.g. a PON, that provides functionality to automate interrogation of a network splitter to determine connectivity between the splitter and a plurality of optical sources. The optical sources may be any optical source that may be addressed as described herein. In the illustrative embodiment of FIG. 2 the optical sources are ONUs. Embodiments described herein refer without limitation to ONUs while recognizing that other optical sources, such as demarcation points, may also be used.

The system 200 includes an OLT 205 and a plurality of ONUs 210a, 210b, 210c. The OLT 205 may be located, e.g. at a service provider central office, and the ONUs 210 may each be located at a subscriber site. The ONUs 210a, 210b, 210c may each be collocated with a corresponding demarcation point (DP) 215a, 215b, 215c. Embodiments are described herein without limitation in terms of communication between the OLT 205 and the ONUs 210. Those skilled in the pertinent art will appreciate that such communications may be between the OLT 205 and the DPs 215, and have the requisite knowledge to make any necessary changes to the described embodiments to support such alternate embodiments.

The system 200 also includes an intelligent splitter monitor (ISM) 220 located between the OLT 205 and the ONUs 210. The ISM 220 may be located at a junction site remote from both the OLT 205 and the ONUs 210. The OLT 205 communicates with the ISM 220 via an optical path 225, e.g. a fiber cable. The ISM 220 communicates with the ONUs 210a, 210b, 210c via corresponding optical paths 230a, 230b, 230c, e.g. fiber cables.

The OLT 205 includes a transmitter 235 and a receiver 240. The transmitter 235 is configured to output modulated light to a first optical multiplexer/demultiplexer 245 for downstream transmission over the optical path 225. The multiplexer/demultiplexer 245 is configured to direct upstream light received from the optical path 225 to the receiver 240. The downstream light from the transmitter 235 may have a first wavelength λ₁, and the upstream light to the receiver 240 may have a second different wavelength λ₂. An optical power source 250, the purpose of which is described below, in some embodiments also provides light to the multiplexer/demultiplexer 245 for transmission via the optical path 225. The light from the optical power source 250 may have a third different wavelength λ₃. A tap message monitor 255, the purpose of which is described below, receives light at wavelength λ₁ or a different wavelength λ₄ via the multiplexer/demultiplexer 245. The tap message monitor 255 includes functionality to convert the received λ₁ or λ₄ light to the electrical domain for subsequent processing.

The ISM 220 includes a second optical multiplexer/demultiplexer 260 connected to the optical path 225. Downstream λ₁ light from the optical path 225 propagates via an unreferenced optical path to a third multiplexer/demultiplexer 265 and then to a splitter/combiner 270. In some embodiments the multiplexer/demultiplexers 260 and 265 may be combined in a single optical device. The multiplexer/demultiplexer 265 directs upstream λ₂ light to the multiplexer/demultiplexer 260 for transmission to the OLT 205. The multiplexer/demultiplexer 260 also directs λ₃ light from the optical power source 250 to an optical power converter 275, e.g. a photodiode. An optical transmitter 280 transmits λ₄ light to the multiplexer/demultiplexer 260 for upstream transmission. The function and purpose of the optical power converter 275 and the optical transmitter 280 are described below.

In various embodiments λ₁ and λ₂ are conventional wavelengths used in PON communications. In a nonlimiting example, λ₁≈1490 nm and λ₂≈1310 nm. In some embodiments λ₃ is selected to limit interference with communication between the OLT 205 and the ISM 220. The selection of λ₃ may also be guided by the optical transmission passband of the various optical paths in the system 200 and the response characteristics of various optical components. One wavelength that meets these objectives is λ₃≈1625 nm, but embodiments are not limited to any particular wavelength.

The splitter/combiner 270 receives λ₁ light from the multiplexer/demultiplexer 260 at an input/output port and divides the light between a plurality of splitter/combiner ports 285a, 285b and 285c. The number of divider ports is not limited to any particular number. The splitter ports 285a-c are connected via optical paths 230a, 230b and 230c to the corresponding ONUs 210a-c. The ONUs 210 are configured to receive the λ₁ light modulated in accordance with applicable PON network communication standards, e.g. IEEE 802.3, ITU-T G.984 or ITU-T G.987. The ONUs 210 are further configured to transmit λ₂ light for upstream transmission to the OLT 205 in accordance with such standards. The light from the several ONUs 210a-c is combined by the splitter/combiner 270 into a composite, e.g. time-domain multiplexed, λ₂ signal for transmission to the OLT 205. The OLT 205 and the ONUs 210 may thus operate as a PON network.

Taps 286a, 286b and 286c each couple a portion of the light transmitted by each corresponding ONU 210a-c to an opto-electric converter 290, e.g. a PIN photodiode bank. The tapped light portions are converted by the opto-electric converter 290 to the electrical domain. An addressable analog electrical multiplexer 292 may optionally be used to selectively route the outputs of the converter 290 to a single output. The multiplexer 292 may be configured to output digital values that indicate the presence or absence of light at each of the taps 286.

A controller 295 includes an electronic device such as a microcontroller, microprocessor or state machine that is configured to poll the outputs of the converter 290 by sequentially addressing the multiplexer 292, and to take certain predetermined actions in response thereto. In some embodiments the controller 295 is configured to receive analog values directly from the converter 290, in which case the multiplexer 292 may be omitted.

The controller 295 may be or include any commercially available or proprietary design, and may include integrated and discrete components in any configuration to provide the functionality described herein. In some embodiments the controller 295 includes a low-power microcontroller designed to use less than about 100 μA/MHz. An example of such a processor is the MSP430 processor manufactured by Texas Instruments, Dallas, Tex., USA. For example in some configurations the MSP430 processor may be operated in a low power mode that consumes about 2 μA at 1.8V, or about 3.6 μW. The controller 295 may further include storage, e.g. nonvolatile memory, in which program instructions, e.g. firmware, are stored.

The optical power source 250, as in the illustrated embodiment, may remotely power the controller 295 using an optical power signal, e.g. the λ₃ light. The optical power converter 275 receives the λ₃ light from the multiplexer/demultiplexer 260 and produces an electrical current and voltage. A power conditioner 297, described further below, produces a power output suitable for operating the controller 295. Aspects of remotely powering the controller 295 are described in European Patent Application EP11292108.7 to Hehmann, et al., incorporated herein by reference in its entirety. In some embodiments the controller 295 is powered by a power source collocated with the ISM 220, in which case the optical power source 250, the optical power converter 275 and the power conditioner 297 may be omitted.

The controller 295 operates to produce an identification (ID) message that identifies the port 285a-c at which an optical signal is received from one of the ONUs 210a-c. For example, the ONU 210b may output an optical signal to the port 285b. The tap 286b may direct a portion of the light to the opto-electric converter 290. The controller 295 may sequentially address the multiplexer 292 to determine that the tap 286b is the source of light. The controller 295 may then generate an appropriate digital message that modulates an optical transmitter 280, e.g. a laser diode, to produce a modulated signal at λ₁ for upstream transmission to the tap monitor 255. In such embodiments the tap monitor 255 may include a readily available optical receiver optimized for receiving light at λ₁. Alternatively, the transmitter 280 may produce a modulated signal with a wavelength λ₄, where λ₄≠λ₁. The signal at λ₄ is not limited to any particular wavelength. A compatible wavelength does not significantly interfere with other optical functions of the system 200 and may be propagated by the optical paths therein. As described further below the tap message monitor 255 may decode the message and respond appropriately, such as by reporting the identity of the port 285b. For example, the tap message monitor 255 may compile a correlation table that correlates each of the taps 286a-c with the identity of the corresponding ONUs 210a-c. An ONU may be identified, e.g. by a serial number or media access control (MAC) address. The correlation table may be stored, forwarded, displayed, etc.

In some embodiments various optical components are provided by a photonic integrated circuit (PIC) 299. In the illustrated embodiment the PIC 299 provides the splitter/combiner 270, taps 286, opto-electric converter 290, optical power converter 275, transmitter 280, the multiplexer/demultiplexers 260 and 265, and the opto-electric converter 290 in a single, integrated optical device. As appreciated by those skilled in the pertinent art, various optical components such as waveguides, waveguide slabs, and photodiodes may be integrated on the PIC 299 using known techniques. Integration of these functions on the PIC 299 may improve reliability, reduce expense and simplify installation relative to embodiments in which these functions are provided by discrete devices. However, embodiments using discrete devices to implement the functionality of the PIC 299 are expressly included within the scope of the disclosure and the claims. For example, the splitter/combiner 270 may be implemented as a fused optical coupler. Moreover, embodiments of the disclosure explicitly include variations on the illustrated ISM 220 that use different optical components than those shown but achieve an equivalent or substantially similar functionality.

FIG. 3 illustrates additional aspects of the operation of the controller 295 and the power conditioner 297. The optical power converter 275 produces a voltage V_{PD} at its output in response to the received λ₃ light. The power conditioner 297 conditions V_{PD} to produce a power source suitable to operate the controller 295. The power conditioner 297 may also power the optical transmitter 280, as well the other active components in the ISM such as the multiplexer 292.

The power converter 297 includes a DC-DC converter 310 and an energy storage device 320. The DC-DC converter 310 converts V_{PD} to a second, typically higher, voltage V_{CC} at which the controller 295 may properly operate. As illustrated the storage device 320 stores energy received from the converter 310. Alternatively the storage device 320 may be located as illustrated in phantom, to store energy at the input to the converter 310.

The storage device 320 may be or include, e.g. an electrolytic capacitor or an electrochemical battery. The storage device 320 will typically have a terminal voltage that increases with time as the charge on the storage device 320 increases. The converter 310 may be configured to hold the controller 295 in a reset state until the storage device 320 is sufficiently charged to operate the controller 295 during an interrogation cycle, described below. Determination of the charge status of the storage device 320 may be by timing or by knowledge of a relationship of the charge state as a function of time and the current and/or voltage input to the storage device 320. Upon the storage device 320 reaching a predetermined charge, the converter 310 may release the controller 295 to operate steps as defined by stored instructions.

The controller 295 may additionally monitor the output of the optical power converter 275, V_{PD}, via a status input and operate in response to a change of V_{PD}. For example, if the λ₃ light is interrupted, the controller 295 may be configured to initiate a shutdown sequence or to otherwise modify its operation in anticipation of exhausting the available charge on the storage device 320.

In a nonlimiting example, the controller 295, transmitter 280 and any supporting electronic devices may have a power draw of about 500 μW. The optical power source 250 may launch a continuous-wave (CW) output signal at 1625 nm with an initial power of about 5 dBm. Due to attenuation within the various optical paths, the power received by the optical power converter 275 may be about 0 dBm. The conversion efficiency of the optical power converter 275 may be about 50%, resulting in an output power of about 200 μW. During an interrogation cycle, e.g. testing a single one of the ONUs 210 and transmitting an ID message (described below) from the controller 295 to the tap monitor 255, the controller 295 and transmitter 280 may consume more power than the storage device 320 is able to store. The capacity of the storage device 320 may be selected such that with continuous illumination of the optical power converter 275 during the interrogation cycle the sum of the stored power and the delivered power is sufficient to power the controller 295. After completion of the interrogation cycle the storage device 320 may be charged again to prepare for another interrogation cycle.

FIG. 4 illustrates a method 400 for operating of the system 200 in one embodiment to interrogate the splitter/combiner 270 to determine connectivity to the ONUs 210. Embodiments of the disclosure include variations on the method 400, such as performing the steps in an order other than the illustrated order.

In a step 410, the optical power source 250 is energized to output light with wavelength λ₃. This step may be initiated on demand, or on a regular schedule, e.g. at night when PON communications are expected to be light. In a step 420, the storage device 320 is charged to a level sufficient to initiate an interrogation cycle. In a step 430 the converter 310 enables the controller 295. In a step 440, an interrogation message from the OLT 205, e.g. a MAC request, may be sent to the ONUs 210a-c to suspend upstream conventional network traffic. In some embodiments a test of an individual one of the ports 285a-c may be interspersed with bursts of conventional network data traffic.

In a step 450, the OLT 205 sends a message addressed to a specific one of the ONUs 210a-c, directing that ONU to respond with a reply message. The reply message may be, e.g. an ONU data packet or a CW signal. The contents and format of the reply message are not limited to any particular type. Rather, it is the act of responding that generates an optical signal that is received at the corresponding port 285a-c. The tap 286 corresponding to the selected ONU 210 directs a portion of the received light to the opto-electric converter 290. In a step 460 the controller polls the multiplexer 292 and determines the port 285 corresponding to the selected ONU 210. The controller forms an identification (ID) message that includes an identification datum that identifies the port 285. The identification datum may be, e.g. the number of the port 285 as determined by addressing the multiplexer 292.

The ID message may be of any format. In one embodiment the ID message is formatted according to the applicable network communication standard. In another embodiment the ID message is formatted to limit its length. For example, if the splitter/combiner 270 has M splitter ports 285, the ID message may include ┌log₂ M┐ digits in a binary data field, e.g. the smallest number of binary digits needed to represent the total number of ports of the ports 285. The ID message may further include a minimum number of bits required for synchronization at the tap message monitor 255. The tap message monitor 255 may be adapted to support the ID message protocol, which may differ from a standard PON message protocol. The ID message may be transmitted by the optical transmitter 280 at λ₁, e.g. 1490 nm, or at a wavelength λ₄ that is different from λ₁, λ₂, and λ₃.

The steps 420-460 may be repeated any number of times, e.g. once for each port 285a-c. After completion of all interrogation cycles the λ₃ signal may be turned off in a step 470 and normal PON network traffic may resume. The tap message monitor 255 may compile the splitter port correlation table as previously described and report this table in any desired manner.

FIG. 5 presents a method 500, e.g. for manufacturing the system 200, including features described in FIGS. 2 and 3. The steps of the method are described without limitation by making reference to the various embodiments described herein, e.g. by FIGS. 2 and 3. Embodiments of the disclosure include variations on the method 500, such as performing the steps in an order other than the illustrated order.

The method 500 begins with a step 510, in which a first optical tap, e.g. the tap 286a, is located to divert a portion of a first optical signal directed to a first port, e.g. the port 285a, of a plurality of ports of an optical combiner, e.g. the splitter/combiner 270.

In a step 520 a controller, e.g. the controller 295, is configured to monitor the diverted optical signal and to create an ID message including an identification datum associated with the port in the event that the diverted optical signal is detected.

In a step 530 an optical transmitter, e.g. the optical transmitter 280, is configured to encode a third optical signal with the ID message. In a step 540 the optical transmitter and the optical combiner are connected to an optical coupler, e.g. the multiplexer/demultiplexer 260. The optical coupler is configured to couple the first and third optical signals to a same optical path, e.g. the optical path 225.

In a step 550 an optical network unit, e.g. the ONU 210, is configured to suspend normal network operation and output the first optical signal in response to a received interrogation message. In a step 560 an optical line terminal, e.g. the OLT 205, is configured to generate the interrogation message. In a step 570 the optical coupler is connected to an optical power converter, e.g. the optical power converter 275.

Those skilled in the art to which this application relates will appreciate that other and further additions, deletions, substitutions and modifications may be made to the described embodiments.

What is claimed is:

1. An optical communication system, comprising:
an optical combiner having a plurality of ports, and being configured to receive a first optical signal at a first port of said plurality of ports;
an optical tap associated with said first port and configured to divert a portion of said first optical signal; and
a controller configured to monitor said diverted portion and to create an ID message including an identification datum associated with said port in the event that said diverted optical signal is detected.

2. The optical communication system of claim 1, wherein said optical tap is configured to receive said first optical signal from an optical network unit configured to communicate with an optical line terminal via an optical path optically coupled to said optical combiner.

3. The optical communication system of claim 2, further comprising said optical network unit, wherein said optical network unit is configured to suspend communication with said optical line terminal before producing said first optical signal.

4. The optical communication system of claim 1, wherein an optical path is configured to receive said first optical signal, and said controller is powered by a second optical signal received via said optical path.

5. The optical communication system of claim 2, further comprising:
an optical transmitter configured to encode a second optical signal with said ID message; and
an optical combiner configured to couple said second optical signal into said optical path.

6. The optical communication system of claim 5, wherein said optical combiner, optical tap, optical transmitter and optical coupler are integrated over a common substrate of a photonic integrated circuit.

7. The optical communication system of claim 2, further comprising said optical line terminal, said optical line terminal being configured to transmit an interrogation signal to said optical network unit via said optical path, said optical network unit being configured to transmit said first optical signal in response to said interrogation signal.

8. The optical communication system of claim 1, further comprising:
an optical line terminal configured to output light with a first wavelength and to receive said first optical signal at a second wavelength;
an optical power source configured to output light with a third wavelength; and
a tap monitor configured to receive said ID message encoded onto an optical signal having a fourth wavelength.

9. The optical communication system of claim 2, further comprising an optical multiplexer/demultiplexer configured to:
couple to said optical path light from said optical line terminal at a first wavelength and light from an optical power source at a second wavelength;
couple to said optical line terminal light received via said optical path at a third wavelength; and
couple to a tap monitor light received via said optical path at a fourth wavelength, wherein said tap monitor is configured to report the identity of said first port.

10. A method, comprising:
locating a first optical tap to divert a portion of a first optical signal directed to a first port of a plurality of ports of an optical combiner;
configuring a controller to monitor said diverted optical signal and to create an ID message including an identification datum associated with said port in the event that said diverted optical signal is detected.

11. The method of claim 10, wherein an optical path is configured to propagate said first optical signal, and said controller is powered by a second optical signal propagated via said optical path.

12. The method of claim 10 further comprising:
configuring an optical transmitter to encode a second optical signal with said ID message; and
connecting said optical transmitter and said optical combiner to an optical coupler configured to couple said first and second optical signals to a same optical path.

13. The method of claim 10, wherein said identification datum is a port number of said optical combiner.

14. The method of claim 11, further comprising configuring an optical network unit to suspend normal network operation and output said first optical signal in response to a received interrogation message.

15. The method of claim 14, wherein said interrogation message has a first wavelength, said first optical signal has a second wavelength, and said second optical signal has a third wavelength.

16. The method of claim 14, further comprising configuring an optical line terminal to generate said interrogation message.

17. The method of claim 12, further comprising connecting said optical coupler to an optical power converter.

18. A method of operating a passive optical network, comprising:
transmitting via an optical path a first optical signal bearing a message to an optical network unit, said first message directing said optical network unit to transmit a second optical signal;
monitoring a combiner port of a splitter/combiner for said presence of said second optical signal;
transmitting via said optical path a third optical signal bearing an ID message identifying said port.

19. The method of claim 18, wherein said first optical signal has a first wavelength, and said second and third optical signals have a second wavelength.

20. The method of claim 19, wherein said ID message is transmitted by a controller powered by light of a third wavelength transmitted via said optical path.
